(19) United States
(12) Patent Application Publication
(10) Pub. No.: US 2021/0262214 A1
(43) Pub. Date: Aug. 26, 2021

(54) BIDET BACKFLOW PREVENTION DEVICE

(71) Applicants: Anjum Gupta, San Diego, CA (US); Ngoc Nguyen, San Diego, CA (US); Bowen Zhang, San Diego, CA (US)

(72) Inventors: Anjum Gupta, San Diego, CA (US); Ngoc Nguyen, San Diego, CA (US); Bowen Zhang, San Diego, CA (US)

(21) Appl. No.: 16/894,329

(22) Filed: Jun. 5, 2020

(30) Foreign Application Priority Data
Feb. 24, 2020 (CN) 202010110749.7

(51) Int. Cl. E03D 9/08; F16K 31/122; F16K 1/12

(52) U.S. Cl. CPC E03D 9/08; F16K 1/46; F16K 1/126; F16K 31/1221

(57) ABSTRACT

The disclosure provides a bidet washing apparatus equipped with a backflow preventer and methods for using the apparatus for preventing backflow of potentially contaminate water into the bidet washing apparatus. The methods utilizing the apparatus include applying water pressure on a backflow preventer in-line with a reservoir dispenser outlet; and releasing the water pressure on the backflow preventer, thereby allowing air to enter the reservoir dispenser outlet, wherein any contaminated water cannot be pulled back into the apparatus by reduced pressure.

### CROSS-REFERENCE TO RELATED APPLICATIONS

This application claims the benefit of priority under 35 U.S.C. § 119 to Chinese Patent Application Serial No. 202010110749.7, titled: “Bidet Anti-Siphon Device,” filed Feb. 24, 2020, the entire disclosure of which is hereby incorporated by reference in its entirety for all purposes.

### TECHNICAL FIELD OF THE INVENTION

The present disclosure generally relates to a bidet washing apparatus and more particularly, to a backflow prevention device for a bidet washing apparatus.

### BACKGROUND OF THE INVENTION

A bidet washing apparatus functions to wash the human body of waste such as urine and fecal matter. The apparatus can be permanently affixed to a toilet or can be removably attached with nuts and bolts. When the apparatus is attached to a water supply source, a spray of water can be generated and directed by a user to a body area as needed.

However, when turning off the water supply source, a negative pressure condition can result in backflow of potentially contaminated water back into the apparatus and mixing with the water supply resulting in contamination of the apparatus. Any residual water remaining in the nozzles or tubes of the apparatus, which have been exposed to a body area, can be contaminated. If the contaminated water in the apparatus is not quickly removed, then bacteria and other dangerous microorganisms may grow inside the apparatus. Upon the next use, the next user can be exposed to the contaminated dangerous water, resulting in risk of disease or health hazard. Currently, no bidet washing apparatuses have any mechanisms for preventing this potential source of contamination. Therefore, there remains a need in the art for safer a bidet washing apparatus that can prevent such contamination.

### SUMMARY OF THE INVENTION

The disclosure addresses these needs and more by providing a bidet washing apparatus equipped with a backflow prevention device; and methods for preventing backflow of potentially contaminated liquid back into the bidet washing apparatus. The apparatus and methods include applying water pressure on a backflow preventer in-line with a reservoir dispenser outlet; and releasing the water pressure on the backflow preventer, thereby allowing air to enter the reservoir dispenser outlet, wherein any contaminated water cannot be pulled back into the apparatus.

Thus, in one embodiment the disclosure provides a bidet washing apparatus, which includes a control unit connectable to a water inlet configured to supply water to the control unit, the control unit including a control unit switch configured to operate a control unit valve for controlling water flow from the water inlet and/or from a control unit outlet; at least one reservoir dispenser having a chamber connected to the control unit outlet, the reservoir dispenser having a reservoir dispenser switch configured to operate a reservoir dispenser valve for controlling water flow from the control unit outlet and/or from a reservoir dispenser outlet; at least one backflow preventer connected in-line and in fluid communication with the at least one reservoir dispenser outlet; and at least one water tube having two ends or at least one water chamber path having two ends, wherein a first end is connected to the reservoir dispenser outlet past the backflow preventer and a second end is connected to a water spray outlet or nozzle.

In other embodiments, the disclosure provides methods for preventing backflow of liquid into a bidet washing apparatus, by applying water pressure in at least one backflow preventer connected in-line and in fluid communication with a reservoir dispenser outlet, thereby creating a sealed chamber; and releasing the water pressure in the at least one backflow preventer, thereby allowing air into the sealed chamber, wherein the bidet washing apparatus is as described herein.

### BRIEF DESCRIPTION OF THE DRAWINGS

Further characteristics of the invention will appear clearer from the detailed description that follows, referring to one of the purely exemplary embodiments and therefore, not limited as illustrated in the attached drawings, in which:

FIG. 1 illustrates an exemplary embodiment of a top rear perspective view of a bidet washing apparatus;

FIG. 2 illustrates another exemplary embodiment of a top rear perspective view of a bidet washing apparatus:

FIG. 3 illustrates an exemplary embodiment of a top cut away perspective view of a bidet washing apparatus;

FIG. 4 illustrates an exemplary embodiment of a top cut-away view of the control unit of a bidet washing apparatus;

FIG. 5 illustrates an exemplary embodiment of a top cut-away view of the reservoir dispenser of a bidet washing apparatus;

FIG. 6 illustrates another exemplary embodiment of a top cut-away view of the reservoir dispenser of a bidet washing apparatus;

FIG. 7 illustrates an exemplary embodiment of a top cut-away exploded view of the reservoir dispenser of a bidet washing apparatus;

FIGS. 8A and 8B illustrate an exemplary embodiment of a back flow preventer reversibly attached to a reservoir dispenser outlet of a bidet washing apparatus;

FIGS. 9A and 9B illustrate an exemplary embodiment of a backflow preventer inlet reversibly attached to a reservoir dispenser of a bidet washing apparatus:

FIG. 10 illustrates an exemplary embodiment of a backflow preventer reversibly attached to a reservoir dispenser outlet of a bidet washing apparatus;

FIG. 11 illustrates an exemplary embodiment of an exploded side view of a backflow preventer of a bidet washing apparatus;

FIG. 12 illustrates an exemplary embodiment of a cut-away cross-sectional view of a backflow preventer of a bidet washing apparatus;

FIG. 13 illustrates an exemplary embodiment of a cut-away cross-sectional view of a backflow preventer of a bidet washing apparatus;

FIG. 14 illustrates an exemplary embodiment of a cut-away cross-sectional view of a backflow preventer of a bidet washing apparatus;

FIG. 15 illustrates a cut-away side view of an unexploded backflow preventer of a bidet washing apparatus;

FIG. 16 illustrates an exemplary embodiment of a cut-away cross-sectional view of a backflow preventer of a bidet washing apparatus;

FIG. 17 illustrates an exemplary embodiment of a cut-away cross-sectional view of a backflow preventer of a bidet washing apparatus; and

FIGS. 18A and 18B illustrate an exemplary embodiment of a stem extruding and not extruding through a cap of a backflow preventer of a bidet washing apparatus.

### DETAILED DESCRIPTION OF THE EMBODIMENTS

The disclosure provides a bidet washing apparatus equipped with a backflow prevention device and methods for preventing backflow of liquid into the bidet washing apparatus, by applying water pressure in at least one backflow preventer connected in-line and in fluid communication with a reservoir dispenser outlet, thereby creating a sealed chamber; and releasing the water pressure in the at least one backflow preventer, thereby allowing air to enter the sealed chamber, wherein any contaminated water cannot be pulled back into the apparatus by reduced pressure.

Thus, in one embodiment the disclosure provides a bidet washing apparatus, having a control unit connectable to a water inlet configured to supply water to the control unit, the control unit including a control unit switch configured to operate a control unit valve for controlling water flow from the water inlet and/or from a control unit outlet; at least one reservoir dispenser having a chamber connected to the control unit outlet, the reservoir dispenser having a reservoir dispenser switch configured to operate a reservoir dispenser valve for controlling water flow from the control unit outlet and/or from a reservoir dispenser outlet; at least one backflow preventer connected in-line and in fluid communication with the at least one reservoir dispenser outlet; and at least one water tube having two ends or at least one water chamber path having two ends, wherein a first end is connected to the reservoir dispenser outlet past the backflow preventer and a second end is connected to a water spray outlet or nozzle.

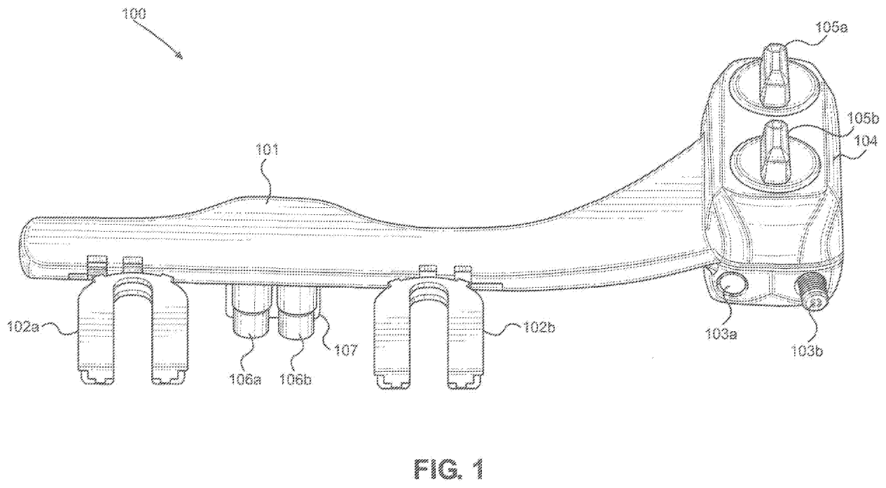

FIG. 1 illustrates an exemplary embodiment of a top rear perspective view of a bidet washing apparatus 100. The apparatus includes a housing unit 101, which can be made of any suitable material, e.g. plastic, polymer composite, metal, and combinations thereof, and serves to support the apparatus; and securing mechanisms 102a and 102b, for securing the apparatus to a toilet. The apparatus also includes water inlets 103a and 103b, which brings water from a water supply source into a control unit 104 of the apparatus. The control unit includes control unit knobs 105a and 105b, which can regulate the flow of water through the apparatus. When a control knob is turned to the “on” position, water flows through the apparatus via a series of water tubes or water chambers (not shown), and through one or more water spray outlets or washing nozzles, shown here as washing nozzles 106a and 106b, wherein each washing nozzle can spray a stream of water upwardly and inwardly towards a user. For sanity purposes, the apparatus can optionally include a gate or shield 107, which protects the nozzles from exposure to contamination when not in use.

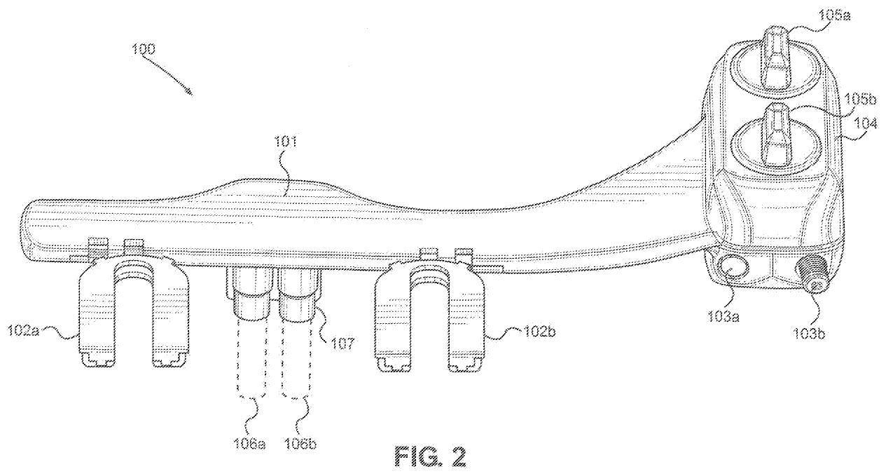

FIG. 2 illustrates another exemplary embodiment of a top rear perspective view of a bidet washing apparatus 100. As shown in this figure, when a control unit knob 105a and/or 105b are turned on, water flows through the apparatus and the positive water pressure causes the two washing nozzles 106a and 106b to be extended below the gate or shield 107 and conversely, when the control knobs are turned off, negative water pressure causes the nozzles to be raised above the gate or shield. In some embodiments, the washing nozzles can also be spring loaded.

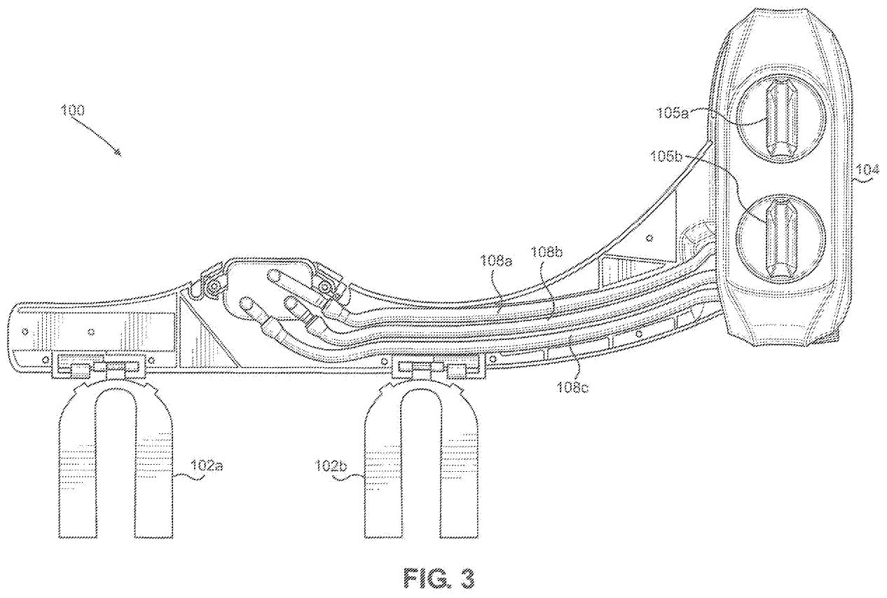

FIG. 3 illustrates an exemplary embodiment of a top cut away perspective view of a bidet washing apparatus 100. As shown in this figure, water tubes 108a, 108b and 108c run from the water control unit 104 to the nozzles (not shown) to deliver a spray of water to the user. In other embodiments and as known in the art, one or more water channels (not shown) can be used instead of, or in addition to the water tubes, for transporting water.

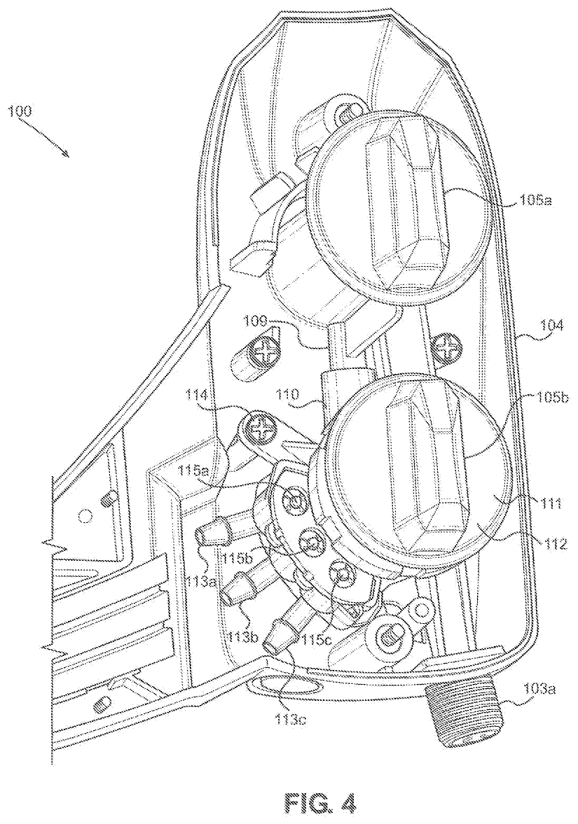

FIG. 4 illustrates an exemplary embodiment of a top cut-away view of the control unit 104 of the bidet washing apparatus 100. In this figure, the apparatus includes water inlet 103a, which is fluidically connected to the control unit 104 to supply water to the apparatus. The control unit includes control unit knobs 105a and/or 105b, which are configured to operate one or more control unit valves or openings (not shown) for controlling water flow from the water inlet and through control unit outlet 109.

As shown in this figure, the apparatus also includes a reservoir dispenser inlet 110 which is fluidically connected to a reservoir dispenser 111 for receiving water from the control unit outlet 109. The reservoir dispenser 110 optionally includes one or more compartments (not shown), and a removable cap or lid 112 for holding soap and/or disinfectant inside the reservoir dispenser.

The reservoir dispenser 111 includes a reservoir dispenser switch, i.e. control unit knob 105b, which is configured to operate one or more reservoir dispenser valves or openings (not shown) for controlling water flow from the control unit and/or from reservoir dispenser outlets.

For example, a water solution in the one or more compartments of the reservoir dispenser 111 can be transferred through one or more of the reservoir dispenser outlets 113a, 113b, and/or 113c to the water spray outlet or nozzles via the water tubes or water chambers as described above, and provide the water solution for washing and cleaning.

Also shown in this figure is a plurality of tabs with openings 114, which can be used as a securing mechanism for securing the control unit and reservoir dispenser to the body of the apparatus, for example, by use of screws, bolts, snaps, and the like.

Finally, as shown in this figure, one or more backflow preventers 115a, 115b, and 115c can be connected in-line with the reservoir dispenser outlet, which can prevent backflow of potentially contaminated water into the reservoir dispenser. As shown in this figure, two or more backflow preventers can be connected in parallel with two or more reservoir dispenser outlets of the reservoir dispenser.

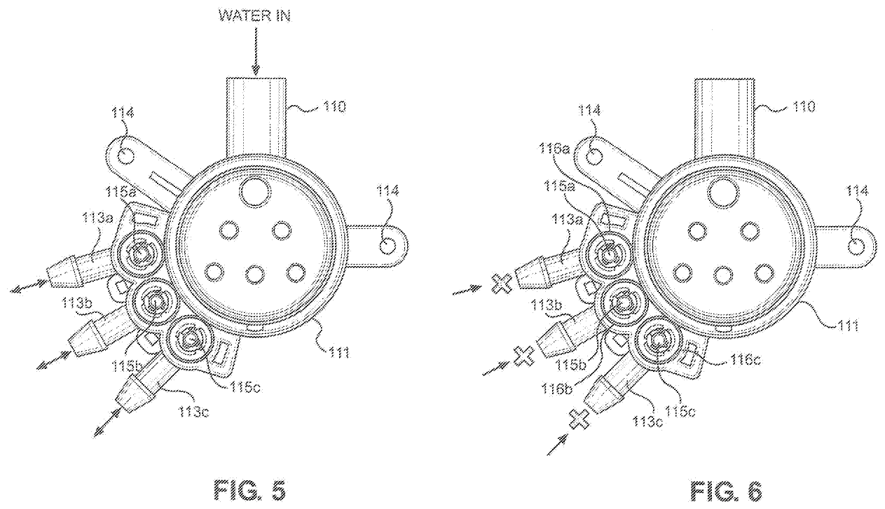

FIG. 5 illustrates an exemplary embodiment of a top cut-away view of the reservoir dispenser 111 of a bidet washing apparatus. As shown in this figure, the reservoir dispenser 111 includes a reservoir dispenser inlet 110; three reservoir dispenser outlets 113a, 113b, and 113c; backflow preventers 115a, 115b, and 115c; and several tabs with an opening 114 for securing the reservoir dispenser to the apparatus. When turning on the water supply source, a positive water pressure is applied through the reservoir dispenser inlet and reservoir dispenser, and water flows freely through the dispenser outlets through the water tubes and nozzles. However, when turning off the water supply source, a negative pressure condition can result in backflow of potentially contaminated water into the reservoir dispenser and mixing with the water supply resulting in contamination. Any residual water remaining in the nozzles or tubes of the apparatus, which have been exposed to a body area, can be contaminated and can flow back, e.g. siphoned back, to the reservoir dispenser under reduced pressure.

FIG. 6 illustrates another exemplary embodiment of a top cut-away view of the reservoir dispenser 111 of a bidet washing apparatus. As shown in this figure, the reservoir dispenser 111 includes a reservoir dispenser inlet 110; three reservoir dispenser outlets 113a, 113b, and 113c; several tabs with an opening 114; and three backflow preventers 115a, 115c, and 115c, which are strategically placed in three backflow preventer holders 116a, 116b, and 116c, located between the reservoir dispenser and the three reservoir dispenser outlets to prevent backflow of any contaminated water into the reservoir dispenser. In some embodiments, there is a backflow preventer holder for each backflow preventer. In other embodiments, there is a cap or a lid (not shown) for securing each backflow preventer in the backflow preventer holder.

As used herein, a backflow preventer is an attachment that prevents water from being pulled backwards by negative pressure into a water system. This prevents contamination should the water system's pressure drop. A backflow preventer can be made of any suitable material including but not limited to plastic, polymer composite, metal or any combination thereof.

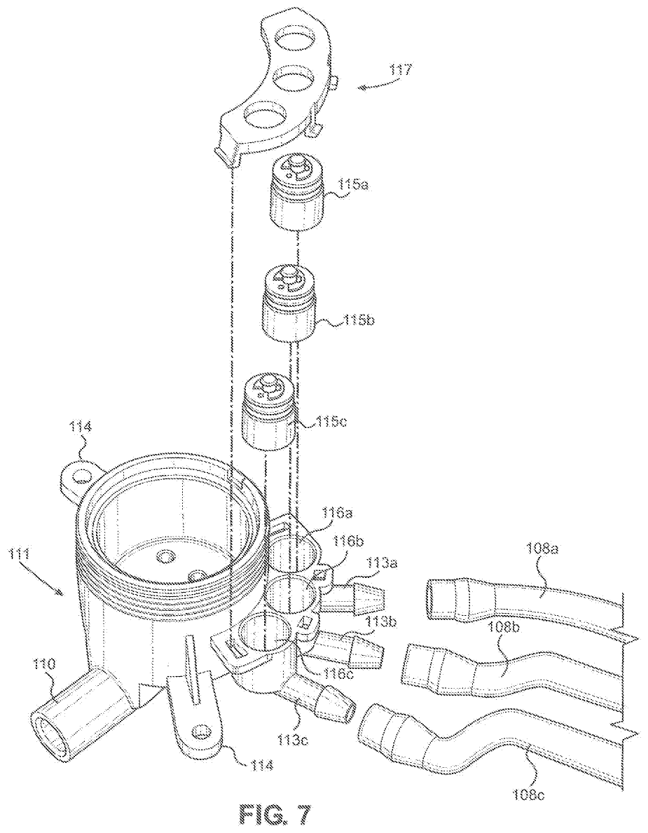

FIG. 7 illustrates an exemplary embodiment of a top cut-away exploded view of a reservoir dispenser 111 of a bidet washing apparatus. As shown in this figure, the reservoir dispenser 111 includes a reservoir dispenser inlet 110; three reservoir dispenser outlets 113a, 113b, and 113c, which are connectable to the three water tubes 108a, 108b, and 108c, respectively; several tabs with an opening 114; and three backflow preventers 115a, 115c, and 115c, which can be placed in the three backflow preventer holders 116a, 116b, and 116c, between the reservoir dispenser 111 and the three reservoir dispenser outlets 113a, 113b, and 113c to prevent backflow of any contaminated water into the reservoir dispenser. Also shown is a cap or lid 117, which can be used to secure the backflow preventers in their respective holders. In some embodiments, the cap or lid can include a snap, a screw-on, a self-locking mechanism, and the like.

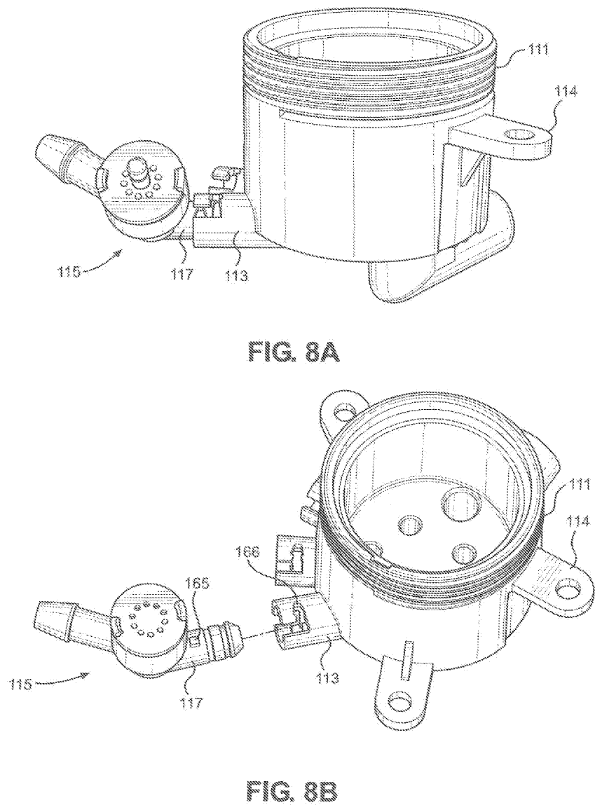

As shown in FIGS. 8A and 8B, in one embodiment a backflow preventer 115 can be reversibly attached to the reservoir dispenser outlet 113 by a screw-on mechanism, a snap-secure mechanism or a combination thereof. In an embodiment, the reservoir dispenser outlet 113 receives a backflow preventer inlet 117, which can be screwed-on and/or turned and snapped into place onto the outlet using snap 165 and slot 166. As shown in this figure, a backflow preventer outlet 118 can take the place of and/or continue the reservoir dispenser outlet 113 to the water tubes or water channels (not shown).

In other embodiments, a backflow preventer 115 can be reversibly attached to the reservoir dispenser outlet, for example by a screw and thread mechanism, a snap-on mechanism, or by any other suitable means.

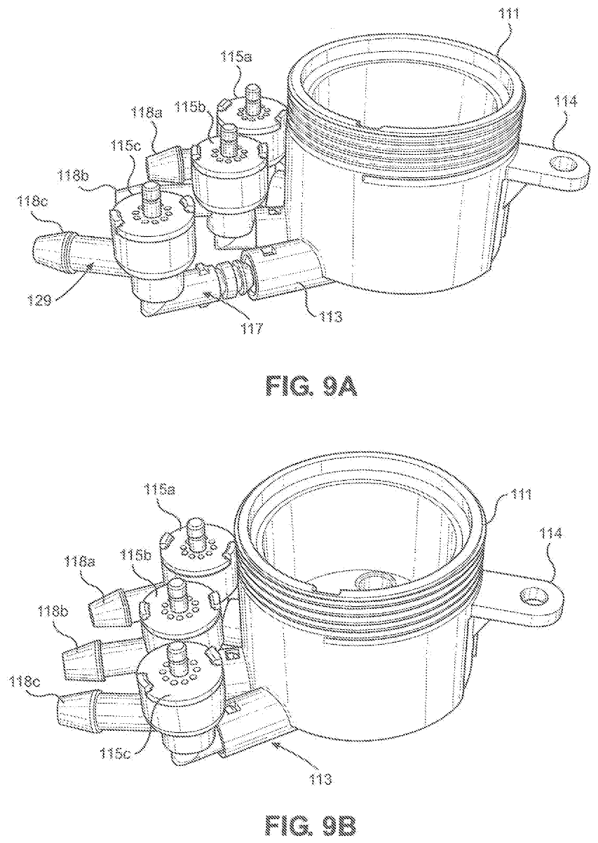

As shown in FIGS. 9A and 9B, the backflow preventer inlet 117 can snap into/onto the reservoir dispenser outlet 113. Also shown in these figures is the reservoir dispenser 111, tab with an opening 114, backflow preventers 115a, 1156, 115c, and backflow preventer outlets 118.

In still other embodiments, the backflow preventer can be permanently attached to the reservoir dispenser outlet, for example by being directly built into the outlet or by being glued onto the outlet.

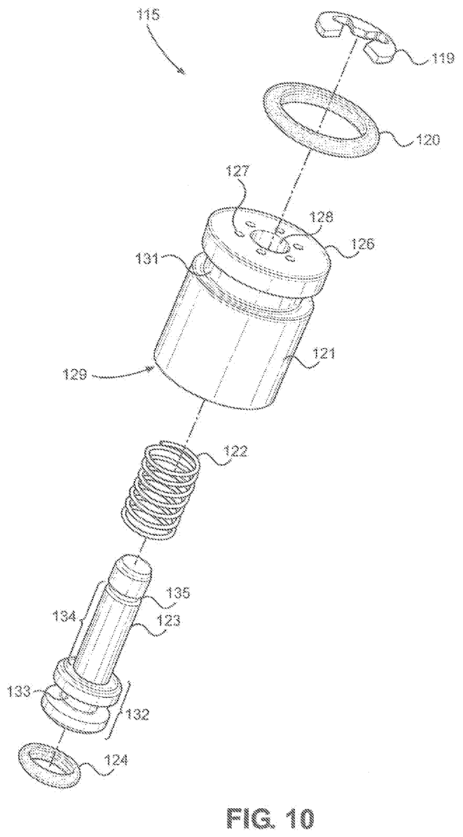

FIG. 10 illustrates an exemplary embodiment of an exploded side view of a backflow preventer 115. As shown in this figure, the backflow preventer 115 includes, from top to bottom, a snap ring 119, an external O-ring 120, a backflow preventer housing unit 121, a spring 122, a stem 123, and an internal O-ring 124.

As shown in this figure, the backflow preventer housing unit 121 includes a top end 126 with a plurality of air holes 127 and a centrally located top end opening 128, in which the stem 123 can be located through. The housing unit 121 also includes a bottom end 129 having a centrally located bottom end opening (130—not shown). In addition, in some embodiments, the housing unit 121 includes a hollowed shaped interior having a tapered region between a larger bottom end interior region and a smaller top end interior region (not shown).

As shown in this figure, the backflow preventer housing unit 121 also includes a longitudinal groove 131 for securing the external O-ring 120.

Also shown in this figure, is the stem 123, which can be located in the hollowed shaped interior of the housing unit. The stem 123 includes a base section 132 with a first longitudinal groove 133, in which the internal O-ring 124 can be secured: a shaft 134 with a second longitudinal groove 135, in which the snap ring 119 can be secured, wherein the stem 123, second longitudinal groove 135 and snap ring 119 can extend through the centrally located top end opening 128.

In some embodiments, the spring 122 can be located between the base section 132 of the stem 123, and the top end 126 of the housing unit 121.

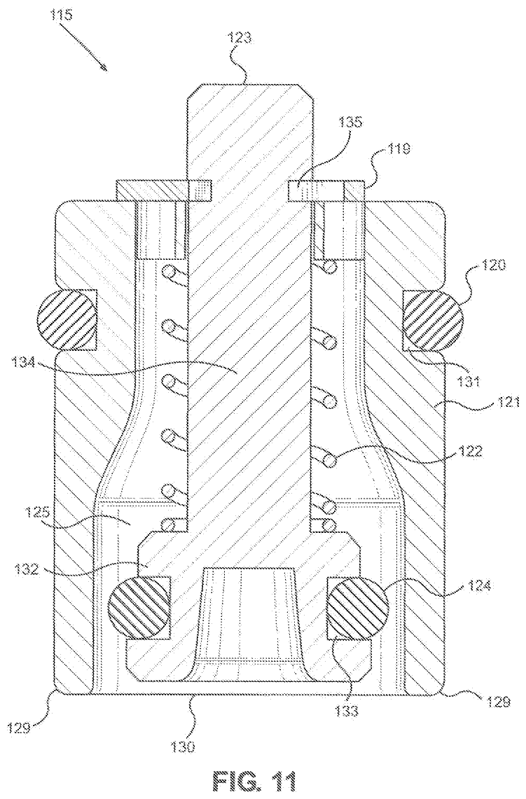

FIG. 11 illustrates an exemplary embodiment of a cut-away cross-sectional view of a backflow preventer 115. As shown in this figure, the backflow preventer 115 includes the backflow preventer housing unit 121 with the centrally located top end opening 128, a bottom end 129, bottom end opening 130, the external O-ring 120 and the longitudinal groove 131, the spring 122, the stem 123, the base of the stem 132, the first longitudinal groove 133, the internal O-ring 124, the shaft of the stem 133, the second longitudinal groove 134 and the snap ring 119. Also shown is a gap or an air-space 125 located between the backflow preventer housing unit 121 and the stem 123.

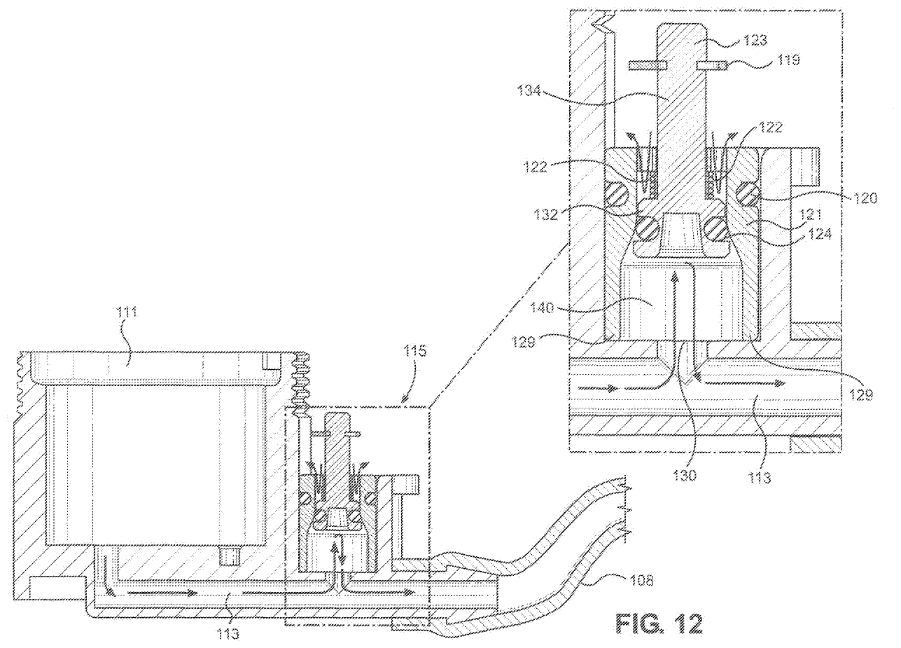

FIG. 12 illustrates an exemplary embodiment of a cut-away cross-sectional view of a backflow preventer 115 in a closed position. As shown in this figure, water flows from the reservoir dispenser 111 through the reservoir dispenser outlet 113 past the backflow preventer 115 and out through the water tube 108 to the nozzles (not shown) for cleaning.

As shown in the expanded window, the backflow preventer 115 includes the backflow preventer housing unit 121 having a top end 126 with a plurality of air holes 127 (not shown), a central top end opening 128, a bottom end 129 with a central bottom end opening 130, and a hollowed shaped interior 136 between the top end opening 128 and the bottom end opening 130. The hollow shaped interior 136 includes a tapered region 137 between a larger bottom end interior region 138 and a smaller top end interior region 139. The stem 123 in the hollowed shaped interior 136 of the housing unit 121 includes a base section 132 with a first longitudinal groove 133 and an internal O-ring 124 in the first longitudinal groove, a shaft 134 with a second longitudinal groove 135 and a snap ring 119 in the second longitudinal groove, wherein the stem, second longitudinal groove and snap ring can extend outside the central top opening 128 of the housing unit 121: and a spring 122 between the base of the stem 132 and the top end 126 of the housing unit.

As shown in this figure, the backflow preventer 115 is attached to the reservoir dispenser 111 through a reservoir dispenser outlet 113. When increased (positive) water pressure is present in the backflow preventer 115, this pushes the stem 123 and internal O-ring 124 upwards and compresses the spring 122, wherein the internal O-ring 124 seals a gap or air space 125 between the stern 123 and the tapered region 137 of the hollowed shaped interior 136 of the housing unit 121 and creates a sealed chamber 140, wherein water cannot get outside the sealed chamber and air cannot get inside the sealed chamber.

FIG. 13 illustrates an exemplary embodiment of a cut-away cross-sectional view of a backflow preventer 115 in an opened position. As shown in this figure, the backflow preventer 115 is attached to the reservoir dispenser 111 through a reservoir dispenser outlet 113. As shown in the expanded window, when reduced or decreased (negative) water pressure is present in the backflow preventer 115, positive outside air pulls the stem 123 and internal O-ring 124 downwards and decompresses the spring 122, wherein movement of the internal O-ring 124 opens the gap or air-space 125 between the stem 123 and the tapered region 137 of the hollowed shaped interior 136 of the housing unit 121 that destroys the sealed chamber 140. The snap ring 119 stops the stem 123 against the top end 126 of the housing unit 121 thereby creating a gap or air-space 124 between the base of the stern 132 and a backflow preventer holder 116, wherein air can enter the backflow preventer 115 through the plurality of air holes 127 in the top end 126 of the stem 123, and wherein water will not be pulled back into the backflow preventer by reduced air pressure. In these embodiments, there will always exist a gap between the bottom of the stem and the backflow preventer holder due to the constraint of the snap ring 118 in the stem 122. This gap allows air to go through snap ring into the gap or air-space and the reservoir dispenser outlet and water tube, thereby clearing any negative pressure and preventing back flow of any contaminated water into the reservoir dispenser.

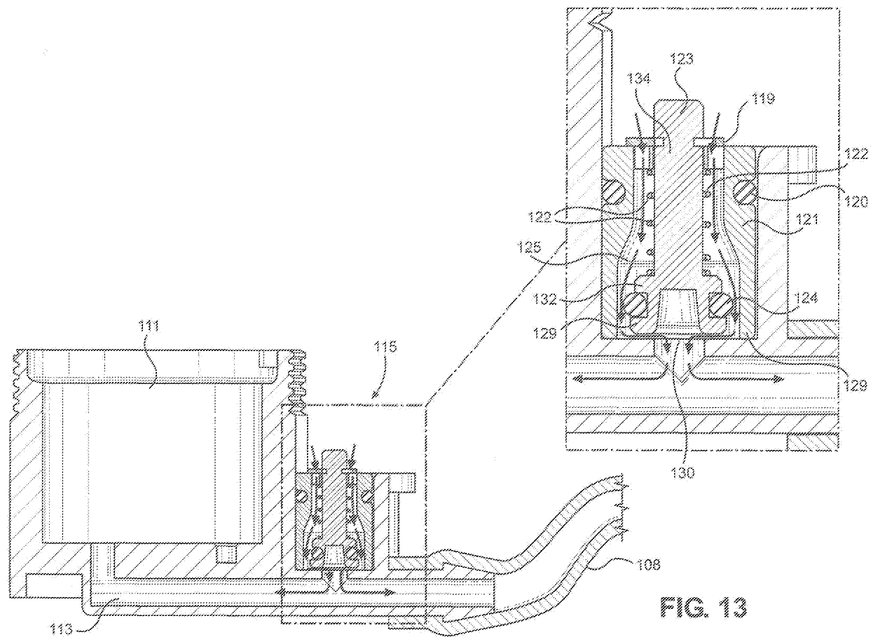

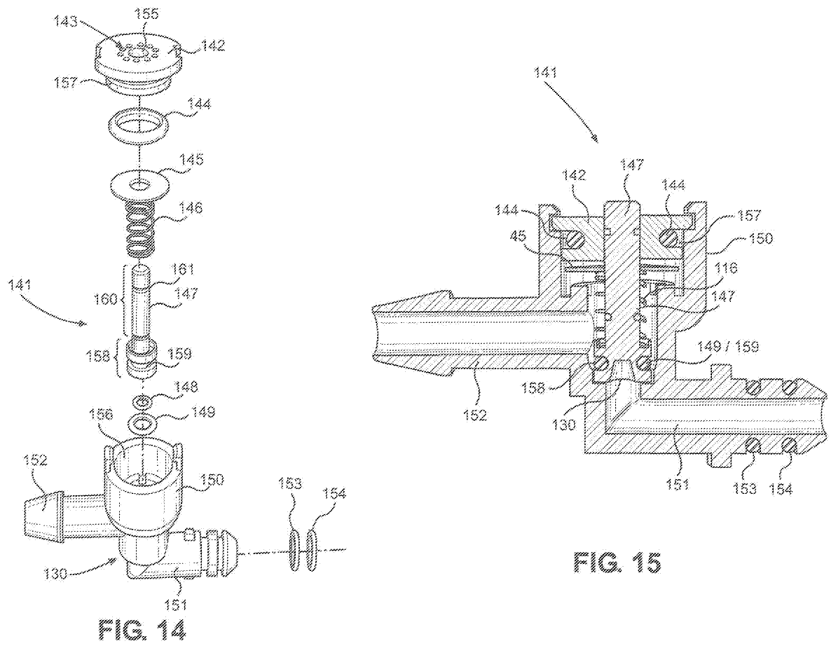

FIG. 14 illustrates another exemplary embodiment of an exploded side view of a backflow preventer 141. As shown in this figure, the backflow preventer 141 includes, from top to bottom, a cap 142 having a plurality of air holes 143, an external O-ring 144, a gasket 145 attachable to a spring 146, a stem 147, an O-ring 148, an internal O-ring 149, a backflow preventer housing unit 150, which includes backflow preventer inlet 151 and backflow preventer outlet 152, and two adjacent O-rings 153 and 154 on the backflow preventer inlet 151 for securing the backflow preventer housing unit 150 to a reservoir dispenser outlet (not shown) of a reservoir dispenser (not shown).

As shown in this figure, the backflow preventer housing unit 150 includes a cap 142 having a plurality of air holes 143 and a centrally located top end opening 155, in which the stem 147 can be located through. In addition, in some embodiments, the housing unit 150 includes a hollowed shaped interior 156 between the backflow preventer inlet 151 and the backflow preventer outlet 152.

As shown in this figure, the cap 142 also includes a longitudinal groove 157 for securing the external O-ring 144.

Also shown in this figure, is the stem 147, which is in the hollowed shaped interior 156 of the housing unit 150. The stem 147 includes a base section 158 with a first longitudinal groove 159, in which the internal O-ring 149 can be secured; a shaft 160 with a second longitudinal groove 161, wherein the stem 147 and second longitudinal groove 161 can optionally extend through the centrally located top end opening 155 of the cap 142.

In some embodiments, the spring 146 can be located between the base section 158 of the stem 147, and the gasket 145.

FIG. 15 illustrates a cut-away side view of an unexploded backflow preventer 141 as described above and shown in exploded FIG. 14. As before, the backflow preventer 141 includes, from top to bottom, a cap 142 having a plurality of air holes 143, an external O-ring 144, a gasket 145 attachable to a spring 146, a stem 147, an O-ring 148, an internal O-ring 149, a backflow preventer housing unit 150, which includes backflow preventer inlet 151 and backflow preventer outlet 152, and two adjacent O-rings 153 and 154 on the backflow preventer inlet 151 for securing the backflow preventer housing unit 150 to a reservoir dispenser outlet (not shown) of a reservoir dispenser (not shown).

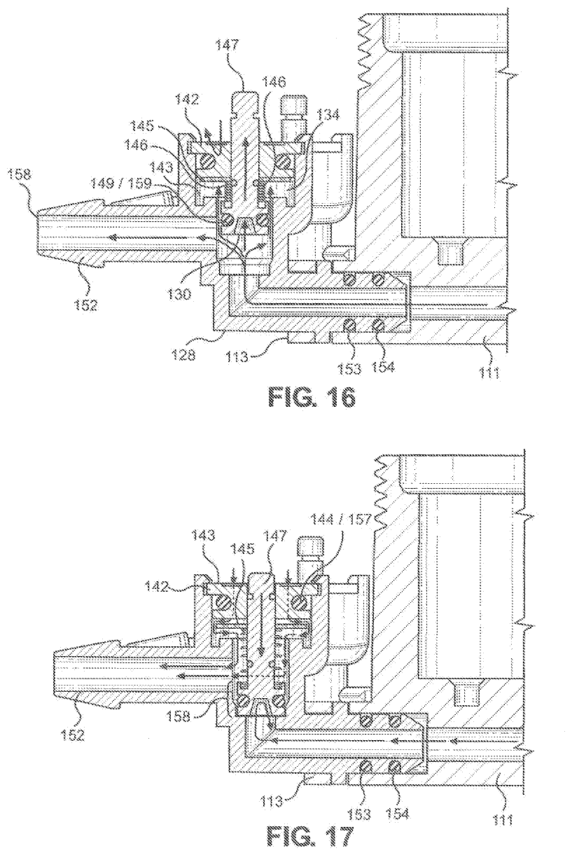

FIG. 16 illustrates an exemplary embodiment of a cut-away cross-sectional view of a backflow preventer 141 in a closed position. As shown in this figure, the backflow preventer 141 is attached to the reservoir dispenser 111 through a reservoir dispenser outlet 113 that is connected with a backflow preventer inlet 151. When increased (positive) water pressure is present in the backflow preventer 141, this pushes the stem 147, internal O-ring 149 and gasket 145 upwards and compresses the spring 146, wherein the gasket 145 seals a bottom end of the cap 142 and plurality of air holes 143 and creates a sealed chamber 162, wherein water cannot get outside the sealed chamber and air cannot get inside the sealed chamber.

FIG. 17 illustrates an exemplary embodiment of a cut-away cross-sectional view of a backflow preventer 141 in an opened position. As shown in this figure, when decreased (negative) water pressure is present in the backflow preventer 141, positive outside air pressure pushes the stem 147, internal O-ring 149 and gasket 145 downwards and decompresses the spring 146, which destroys the sealed chamber 162, wherein air can enter the backflow preventer 141 through the plurality of holes 143 in the cap 142 and around the gasket 145, wherein the internal O-ring 149 and hollowed shape interior 156 of the housing unit 150 seals the backflow preventer inlet 151, and wherein water cannot be pulled back into the backflow preventer by reduced air pressure. That is, the gasket 145 separates from the cap 142, allowing air to flow through the plurality of air holes 143 past a gap 163 created by the lowered gasket 145 and spring 146, and out the backflow preventer outlet 152, thereby clearing any negative pressure and preventing backflow of any contaminated water into the backflow preventer inlet 128 and/or the reservoir dispenser outlet 113. In addition, the internal O-ring 149 on the stem 147 seals against a lower wall of the hollowed shaped interior region 156 of backflow preventer 141, preventing any potentially contaminated water from entering the backflow preventer inlet and/or the reservoir dispenser outlet.

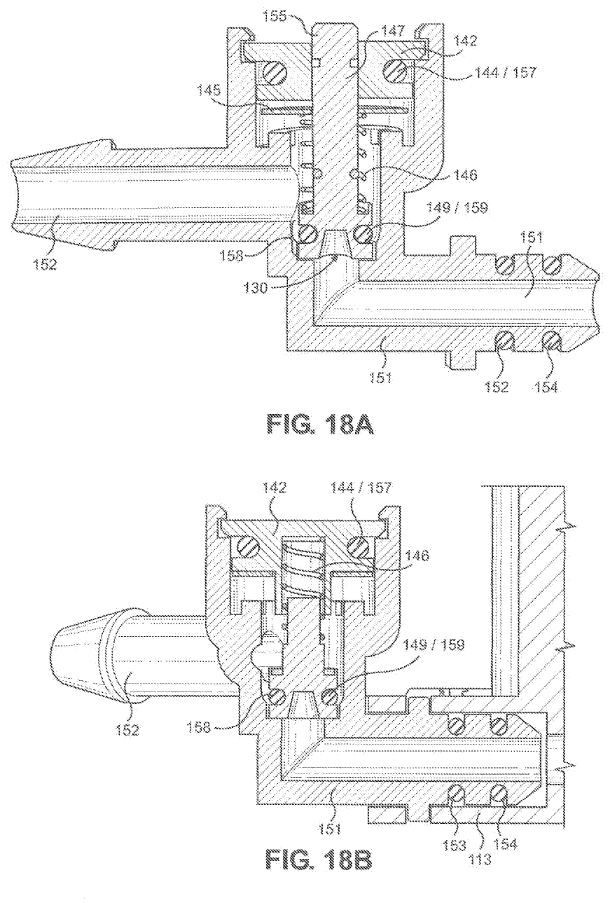

As shown in FIGS. 18A and 18B, in some embodiments the stem 147 can extend through the central top opening 155 of the cap 142 (18A), and in other embodiments, the stem 147 can extend into but not through the cap 142 (18B). In addition, in FIG. 18A the spring 146 is between the base of the stem 158 and the gasket 145. That is, the gasket is below the cap and the spring is between the base of the stem and the gasket. By contrast, in FIG. 18B the spring 146 can be between around mid-region of the stem 147 and the cap 142.

While the inventive features have been particularly shown and described with reference to the disclosed embodiments, it will be understood by those in the art that the foregoing and other changes can be made therein without departing from the sprit and the scope of the disclosure. Likewise, the various diagrams may depict an example architectural or other configuration for the disclosure, which is done to aid in understanding the features and functionality that can be included in the disclosure. The disclosure is not restricted to the illustrated example architectures or configurations but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus, the breadth and scope of the disclosure should not be limited by any of the above-described exemplary embodiments.

What is claimed is:

1. A bidet washing apparatus, comprising:
a control unit connectable to a water inlet configured to supply water to the control unit, the control unit including a control unit switch configured to operate a control unit valve for controlling water flow from the water inlet and/or from a control unit outlet;
at least one reservoir dispenser having a chamber connected to the control unit outlet, the reservoir dispenser having a reservoir dispenser switch configured to operate a reservoir dispenser valve for controlling water flow from the control unit outlet and/or from a reservoir dispenser outlet;
at least one backflow preventer connected in-line and in fluid communication with the at least one reservoir dispenser outlet; and
at least one water tube having two ends or at least one water chamber path having two ends, wherein a first end is connected to the reservoir dispenser outlet past the backflow preventer and a second end is connected to a water spray outlet or nozzle.

2. The bidet washing apparatus of claim 1, further comprising two or more backflow preventers connected in parallel with two or more reservoir dispenser outlets of a reservoir dispenser.

3. The bidet washing apparatus of claim 1, further comprising a backflow preventer holder for each backflow preventer.

4. The bidet washing apparatus of claim 3, further comprising a cap or lid for securing each backflow preventer in the at least one backflow preventer holder.

5. The bidet washing apparatus of claim 1, wherein the backflow preventer comprises:
a housing unit having a top end with a plurality of air holes and a central top end opening, a bottom end with a central bottom end opening, and a hollowed shaped interior between the top end opening and bottom end opening, the hollow shaped interior having a tapered region between a larger bottom end interior region and a smaller top end interior region;
a stem in the hollowed shaped interior of the housing unit, the stem having a base section with a first longitudinal groove and an internal O-ring in the first longitudinal groove, and a shaft with a second longitudinal groove and a snap ring in the second longitudinal groove, wherein the stem, second longitudinal groove and snap ring extends outside the central top opening of the housing unit; and
a spring between the base of the stem and the top end of the housing unit.

6. The bidet washing apparatus of claim 5, wherein increased water pressure in the backflow preventer pushes the stem and internal O-ring upwards and compresses the spring, wherein the internal O-ring seals a gap between the stem and the tapered region of the hollowed shaped interior of the housing unit and creates a sealed chamber, wherein water cannot get outside the sealed chamber and air cannot get inside the sealed chamber.

7. The bidet washing apparatus of claim 6, wherein decreased water pressure in the backflow preventer pulls the stem and internal O-ring downwards and decompresses the spring, wherein the internal O-ring opens a gap between the stem and the tapered region of the hollowed shaped interior of the housing unit that destroys the sealed chamber, and wherein the snap ring stops the stem against the top end of the housing unit thereby creating an air gap between the base of the stem and a backflow preventer holder, wherein air can enter the backflow preventer through the plurality of air holes in the top end of the stem, and wherein water cannot be pulled back into the backflow preventer by reduced air pressure.

8. The bidet washing apparatus of claim 1, wherein the backflow preventer comprises:
a housing unit having a top end with a top end opening, a bottom end with a backflow preventer inlet, a side end with a backflow preventer outlet, and a hollowed shaped interior between the top end opening, side end and bottom end;
a cap having a plurality of air holes, wherein the cap is secured onto the top end of the housing unit:
a stem in a hollowed shaped interior of the housing unit above the backflow preventer inlet and adjacent to the backflow preventer outlet, the stem having a base section with a first longitudinal groove and an internal O-ring in the first longitudinal groove, and a shaft, wherein the base is wider than the shaft; and
a gasket and a spring, wherein the gasket is below the cap and the spring is between the base of the stem and the gasket, or the gasket is below the cap and the spring is between a mid-region of the stem and an internal region of the cap.

9. The bidet washing apparatus of claim 8, wherein increased water pressure in the backflow preventer pushes the stem, internal O-ring and gasket upwards and compresses the spring, wherein the gasket seals a bottom end of the cap and creates a sealed chamber, wherein water cannot get outside the sealed chamber and air cannot get inside the sealed chamber.

10. The bidet washing apparatus of claim 8, wherein decreased water pressure in the backflow preventer pulls the stem, internal O-ring and gasket downwards and decompresses the spring, which opens the sealed chamber and air can enter the backflow preventer through the plurality of holes in the cap and around the gasket, wherein the internal O-ring on the base section of the stem presses against the hollowed shape interior of the housing unit and seals the backflow preventer inlet, and wherein water cannot be pulled back into the backflow preventer by reduced air pressure.

11. The bidet washing apparatus of claim 1, further comprising that a backflow preventer inlet is permanently attached to the reservoir dispenser outlet or is reversibly attachable to the reservoir dispenser outlet.

12. The bidet washing apparatus of claim 11, wherein the backflow preventer inlet is reversibly attachable to the reservoir dispenser outlet by a snap-on mechanism, a screw mechanism, or a turn and snap-on mechanism.

13. The bidet washing apparatus of claim 1, further comprising that the backflow preventer is made of plastic, polymer composite, metal or combinations thereof.

14. A method of preventing backflow of liquid into a bidet washing apparatus, the method comprising:
applying water pressure in at least one backflow preventer connected in-line and in fluid communication with a reservoir dispenser outlet, thereby creating a sealed chamber; and
releasing the water pressure in the at least one backflow preventer, thereby allowing air into the sealed chamber, wherein the bidet washing apparatus includes:
a control unit connectable to a water inlet configured to supply water to the control unit, the control unit including a control unit switch configured to operate a control unit valve for controlling water flow from the water inlet and/or from a control unit outlet;
at least one reservoir dispenser having a chamber connected to the control unit outlet, the reservoir dispenser having a reservoir dispenser switch configured to operate a reservoir dispenser valve for controlling water flow from the control unit outlet and/or from a reservoir dispenser outlet;
at least one backflow preventer connected in-line and in fluid communication with the at least one reservoir dispenser outlet; and
at least one water tube having two ends or at least one water chamber path having two ends, wherein a first end is connected to the reservoir dispenser outlet past the backflow preventer and a second end is connected to a water spray outlet or nozzle.

15. The method of claim 14, further comprising two or more backflow preventers connected in parallel with two or more reservoir dispenser outlets of a reservoir dispenser.

16. The method of claim 14, further comprising a backflow preventer holder for each backflow preventer.

17. The method of claim 16, further comprising a cap or lid for securing each backflow preventer in the at least one backflow preventer holder.

18. The method of claim 14, wherein the backflow preventer comprises:
a housing unit having a top end with a plurality of air holes and a central top end opening, a bottom end with a central bottom end opening, and a hollowed shaped interior between the top end opening and bottom end opening, the hollow shaped interior having a tapered region between a larger bottom end interior region and a smaller top end interior region;
a stem in the hollowed shaped interior of the housing unit, the stem having a base section with a first longitudinal groove and an internal O-ring in the first longitudinal groove, and a shaft with a second longitudinal groove and a snap ring in the second longitudinal groove, wherein the stem, second longitudinal groove and snap ring extends outside the central top opening of the housing unit; and
a spring between the base of the stem and the top end of the housing unit.

19. The method of claim 18, wherein increased water pressure in the backflow preventer pushes the stem and internal O-ring upwards and compresses the spring, wherein the internal O-ring seals a gap between the stem and the tapered region of the hollowed shaped interior of the housing unit and creates a sealed chamber, wherein water cannot get outside the sealed chamber and air cannot get inside the sealed chamber.

20. The method of claim 19, wherein decreased water pressure in the backflow preventer pulls the stem and internal O-ring downwards and decompresses the spring, wherein the internal O-ring opens a gap between the stem and the tapered region of the hollowed shaped interior of the housing unit that destroys the sealed chamber, and wherein the snap ring stops the stem against the top end of the housing unit thereby creating an air gap between the base of the stem and a backflow preventer holder, wherein air can enter the backflow preventer through the plurality of air holes in the top end of the stem, and wherein water cannot be pulled back into the backflow preventer by reduced air pressure.

21. The method of claim 14, wherein the backflow preventer comprises:
a housing unit having a top end with a top end opening, a bottom end with a backflow preventer inlet, a side end with a backflow preventer outlet, and a hollowed shaped interior between the top end opening, side end and bottom end;
a cap having a plurality of air holes, wherein the cap is secured onto the top end of the housing unit;
a stem in a hollowed shaped interior of the housing unit above the backflow preventer inlet and adjacent to the backflow preventer outlet, the stern having a base section with a first longitudinal groove and an internal O-ring in the first longitudinal groove, and a shaft, wherein the base is wider than the shaft; and
a gasket and a spring, wherein the gasket is below the cap and the spring is between the base of the stem and the gasket, or the gasket is below the cap and the spring is between a mid-region of the stem and an internal region of the cap.

22. The method of claim 21, wherein increased water pressure in the backflow preventer pushes the stem, internal O-ring and gasket upwards and compresses the spring, wherein the gasket seals a bottom end of the cap and creates a sealed chamber, wherein water cannot get outside the sealed chamber and air cannot get inside the sealed chamber.

23. The method of claim 21, wherein decreased water pressure in the backflow preventer pulls the stem, internal O-ring and gasket downwards and decompresses the spring, which opens the sealed chamber and air can enter the backflow preventer through the plurality of holes in the cap and around the gasket, wherein the internal O-ring on the base section of the stem presses against the hollowed shape interior of the housing unit and seals the backflow preventer inlet, and wherein water cannot be pulled back into the backflow preventer by reduced air pressure.

24. The method of claim 14, further comprising that a backflow preventer inlet is permanently attached to the reservoir dispenser outlet or is reversibly attachable to the reservoir dispenser outlet.

25. The method of claim 24, wherein the backflow preventer inlet is reversibly attachable to the reservoir dispenser outlet by a snap-on mechanism, a screw mechanism, or a turn and snap-on mechanism.

26. The method of claim 14, further comprising that the backflow preventer is made of plastic, polymer composite, metal or combinations thereof.
